(19) United States
(12) Patent Application Publication
(10) Pub. No.: US 2001/0030794 A1
(43) Pub. Date: Oct. 18, 2001

(54) Electrochromic device

(76) Inventors: Horst Berneth, Leverkusen (DE); Siegfried Hunig, Wurzburg (DE); Christoph Alexander Briehn, Blaustein (DE); Sevn Aldenkortt, Wurzburg (DE)

Correspondence Address: BAYER CORPORATION, PATENT DEPARTMENT, 100 BAYER ROAD, PITTSBURGH, PA, 15205, US

(21) Appl. No.: 09/756,067

(22) Filed: Jan. 8, 2001

(30) Foreign Application Priority Data
Jan. 13, 2000 (DE) 10001031.8

(51) Int. Cl. G02F 1/15; G02F 1/153

(52) U.S. Cl. 359/273; 359/275; 359/265; 359/269; 359/270

(57) ABSTRACT

An electrochromic device comprising two plates or films, of which at least one is transparent and which are provided with a conductive layer on the sides facing one another, where at least one of the conductive layers is transparent, where the plates or films and a sealing ring define a volume in which an electrochromic medium is located comprising at least one reducible compound OX₂ and at least one oxidizable compound RED₁ which convert into their respective redox states RED₂ and OX, by taking up electrons at the negative electrode or by releasing electrons at the positive electrode, where, after charge equalization between RED₂ and OX₁, the original redox states OX₂ and RED₁ are in each case re-formed, wherein at least one RED₁ or OX₂ is an electrochromic compound in which two identical or different coloring units are connected via at least one bridge in such a way that, on oxidation or reduction, a σ-bond is formed or broken between the two units with a color change of the compound in question, is distinguished by improved properties.

### FIELD OF THE INVENTION

The present invention relates to an electrochromic device, and to electrochromic substances.

### BACKGROUND OF THE INVENTION

Electrochromic devices which contain an electrochromic system are already known. Electrochromic systems change their spectral absorption under the influence of an electric field.

WO-A 94/23333 compares electrochromic materials having different constructions, but these are not used as display devices:

Construction a: The electrochromic substances are in the form of a fixed film or layer on the electrodes.

Construction b: The electrochromic substances are deposited on the electrodes as a film by the redox process.

Construction c: The electrochromic substances remain permanently in solution.

For construction a), the best-known electrochromic material is the tungsten oxide/palladium hydride pair.

For construction b), viologens have been described as electrochromic substances. These devices are not self-erasing, i.e. the image produced remains after the voltage has been switched off and can only be erased again by reversing the voltage. Such devices are not particularly stable and do not allow a large number of switching cycles. In addition, the cells constructed using tungsten oxide/palladium hydride in particular cannot be operated in transmitted light, but only reflectively, owing to light scattering at these electrochromic layers.

Elektrokhimiya 13, 32-37 (1977), U.S. Pat. No. 4,902,108 and U.S. Pat. No. 5,140,455 disclose an electrochromic system of the latter construction c). An electrochromic cell built up from glass plates with a conductive coating contains a solution of a pair of electrochromic substances in an inert solvent.

The pair of electrochromic substances used is one electrochemically reversibly reducible substance and one reversibly oxidizable substance. Both substances are colorless or only weakly colored in the ground state. Under the action of an electric voltage, one substance is reduced and the other oxidized, both becoming colored. When the voltage is switched off, the ground state re-forms in the case of both substances, decolorization or a color lightening taking place.

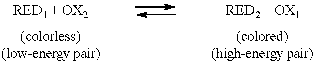

U.S. Pat. No. 4,902,108 discloses that suitable pairs of redox substances are those in which the reducible substance has at least two chemically reversible reduction waves in the cyclic voltammogram and the oxidizable substance correspondingly has at least two chemically reversible oxidation waves.

According to WO-A 94/23333, however, such solution systems of construction c) have serious disadvantages: diffusion of the electrochromic substances in the solution causes unsharp color boundaries and high power consumption in order to maintain the colored state, since the colored substances are permanently degraded by recombination and reaction at the opposite electrode in each case.

Nevertheless, various applications have been described for such electrochromic cells of construction c. For example, they can be formed as automobile rear-view mirrors which can be darkened during night driving by application of a voltage and thus prevent dazzling by the headlamps of following vehicles (U.S. Pat. No. 3,280,701, U.S. Pat. No. 4,902,108 and EP-A 0 435 689). Furthermore, such cells can also be employed in window panes or automobile sunroofs, where they darken the sunlight after application of a voltage. Likewise described is the use of such devices as electrochromic display devices, for example in segment or matrix displays having structured electrodes (DE 196 31 728).

Electrochromic devices consist of a pair of glass or plastic plates, each of which is provided on one side with an electrically conductive coating, for example indium-tin oxide (ITO). At least one of these plates is transparent. In the case of an automobile mirror, one of the plates is mirrored. These plates are used to construct a cell by bonding them, preferably adhesively bonding them, with their electroconductively coated side facing one another, with a ring-shaped or rectangular sealing ring. The sealing ring produces a uniform separation between the plates, of, for example, from 0.01 to 0.5 mm. This cell is filled with an electrochromic medium. The two plates can be provided separately with contacts via the electrically conductive layers.

In electrochromic display devices, at least one of the two electrically conductive layers is divided into area segments which are electrically insulated from one another and can be provided with individual electrical contacts. The provision of these area segments with contacts takes place via electrical leads, each of which leads to an edge of the associated plate and is connected there to a power source, for example via clamps, solder points, conductive lacquer or other electrically conducting compounds.

The known electrochromic substances are generally distinguished by pairs of redox substances which, after reduction or oxidation of colored free radicals, form cationic free radicals or anionic free radicals which are chemically reactive. As disclosed, for example, in Topics in Current Chemistry, Vol. 92, pp. 1-44 (1980), such free-radical (ions) may be sensitive to electrophiles or nucleophiles or even free radicals. In order to achieve high stability of an electrochromic device containing an electrochromic system of this type which is to survive several thousand switching cycles, it must therefore be ensured that the electrochromic medium is absolutely free from electrophiles, for example protons, nucleophiles and oxygen. Furthermore, it must be ensured that reactive species of this type do not form during operation of the electrochromic device through electrochromic processes at the electrodes.

Accordingly, there is a demand for an electrochromic system which comprises at least one electrochromic substance which, after reduction or oxidation, is not converted into a free-radical (ion) species, but instead has a closed electron shell in reduced and oxidized form in order to avoid undesired free-radical reactivity of the colored species.

There is furthermore a demand for an electrochromic system in which the species formed by oxidation or reduction have improved light fastness, high color strength and readily adaptable color shades.

### SUMMARY OF THE INVENTION

The invention relates to an electrochromic device comprising (a) two plates or films in which the facing sides are provided with an electrically conductive layer, wherein at least one such plate or film is transparent and at least one such conductive layer is transparent, and (b) a sealing ring joining the plates or films such that the volume formed by the two plates or films and the sealing ring is filled with an electrochromic medium. The electrochromic medium comprises at least one reducible compound OX₂ and at least one oxidizable compound RED, that converts into their respective redox states RED₂ and OX₁ by taking up electrons at the negative electrode or by releasing electrons at the positive electrode, wherein, after charge equalization between RED₂ and OX₁, the original redox states OX₂ and RED₁ are in each case re-formed, wherein at least one RED₁ or OX₂ is an electrochromic compound in which two identical or different coloring units are connected via at least one bridge in such a way that, on oxidation or reduction, a σ-bond is formed or broken between the two units with a color change of the compound in question. The invention also relates to an electrochromic compound.

### DESCRIPTION OF THE FIGURES

These and other features, aspects, and advantages of the present invention will become better understood with reference to the following description and appended claims, where

FIG. 1 is a sketch of a cell according to Example 8.

FIGS. 2-8 are figures depicting spectroelectrochemical studies.

### DESCRIPTION OF THE INVENTION

The invention accordingly relates to an electrochromic device comprising two plates or films, of which at least one is transparent and which are provided with a conductive layer on the sides facing one another, where at least one of the conductive layers is transparent, where the plates or films and a sealing ring define a volume in which an electrochromic medium is located, wherein at least one RED₁ or OX₂ is an electrochromic compound in which two identical or different coloring units are connected via at least one bridge in such a way that, on oxidation or reduction, σ-bond is formed or broken between the two units with a color change of the compound in question.

For particular use forms, electrochromic substances according to the invention are also intended which convert into coloring units which, in particular, have strong absorption in the spectral regions outside the visible region, provided that the electrochromic substance itself exhibits no or only weak absorption in this region. In particular, the near infrared region is meant here. The coloring units may additionally also absorb in the visible spectral region, but do not have to.

Also covered are electrochromic devices according to the invention which are not colorless or weakly colored, but instead are themselves colored and, due to oxidation or reduction with breaking or formation of a σ-bond, form strong absorption in the visible part of the spectrum which is sufficiently different from that of the electrochromic compound. For example, red electrochromic compounds, which convert into, for example, blue dyes after oxidation or reduction, are thus intended.

In particular, these are electrochromic devices according to the invention, characterized in that the electrochromic medium comprises at least one reducible substance OX₂ and at least one oxidizable substance RED₁ which are colorless or weakly colored and are converted into the respective RED₂ and OX₁ forms by electron take-up at the negative electrode or by electron donation at the positive electrode, where at least OX₂ and/or at least one RED₁ is a substance which is converted into at least one methine dye through reduction or oxidation with breaking or formation of a a-bond, and where, after charge equalization between RED₂ and OX₁, in each case the original forms OX₂ and RED₁ are re-formed again.

Other suitable OX₂ and RED₁ which can be present in addition to the electrochromic substances according to the invention which produce methine dyes through the breaking or formation of a σ-bond are, in particular, the electrochromic substances described above and known from the literature. They are described in greater detail below.

Preference is given to an electrochromic device in which the two redox states of the electrochemical compound RED₁ or OX₂, which interconvert through the formation or breaking of a -bond, have absorption maxima which differ by at least 70 nm, preferably by at least 100 nm, where at least one of the absorption maxima is in the visible part of the spectrum.

The redox state which absorbs at long wavelength here either exists with the σ-bond open or closed, it being possible for this redox state which absorbs at long wavelength to be produced either by reduction or by oxidation.

The two redox states OX₂ and RED₂ or RED₁ and OX₁ of the electrochromic compound correspond to one of the following types

[chemical structure]

[chemical structure]

in which the units V═Z—W and X═Z—Y which absorb at long wavelength represent methine dyes and

B represents a bridge.

The electrochromic device according to the invention comprises at least one OX₂ of the formula (I)

[chemical structure]

in which X¹, X², Y¹ and Y², independently of one another, are a hetero atom, such as N, O, S, Se or P, which, in the case of O, S and Se, may also carry a substituent and is then positively charged and in the case of N and P may also carry two substituents and in the second case is positively charged,

Z¹¹ to Z¹⁷ and Z²¹ to Z²⁷, independently of one another, are C, which also carries a substituent, or N,

B is a bridge formed between one of the atoms in the group X¹, Z¹¹ to Z¹³, Z¹⁵ to Z¹⁷ and Y¹, and one of the atoms in group X², Z²¹ to Z²³, Z²⁵ to Z²⁷ and Y², and

n, m, o and p, independently of one another, are an integer from 0 to 5, and/or at least RED₁ of the formula (II)

[chemical structure]

in which

X³, X⁴, Y³ and Y⁴, independently of one another, are a hetero atom, such as N, O, S, Se or P, which, in the case of O, S and Se, also carries a substituent or a negative charge and in the case of N and P also carries two substituents,

Z³¹ to Z³⁵ and Z⁴¹ to Z⁴⁵, independently of one another, are C, which also carries a substituent, or N,

B is a bridge formed between one of the atoms in the group X³, Z³¹, Z³², Z³⁴, Z³⁵ and Y³ and one of the atoms in the group X⁴, Z⁴¹, Z⁴², Z⁴⁴, Z⁴⁵ and Y⁴, and

q, r, s and t, independently of one another, are an integer from 0 to 5, and/or at least one RED, of the formula (III)

[chemical structure]

in which

X⁵ and X⁶, independently of one another, are a hetero atom, such as N, O, S, Se or P, which, in the case of O, S and Se, also carries a substituent or a negative charge and in the case of N and P also carries two substituents,

Y⁵ and Y⁶, independently of one another, are a hetero atom, such as N or P, or C, which also carries a substituent, Q⁵ and Q⁶, independently of one another, are a hetero atom, such as N or P, which also carry a substituent, or C, which also carries two substituents,

Z⁵², Z⁵², Z⁵⁴ to Z⁵⁶ and Z⁶¹, Z⁶², Z⁶⁴ to Z⁶⁶, independently of one another, are C, which also carries a substituent, or N,

Z⁵³ to Z⁶³ are C, which also carries a substituent if w or z is 1,

B is a bridge formed between one of the atoms in the group X⁵, Z⁵¹ to Z⁵⁶ and Q⁵ and one of the atoms in the group X⁶, Z⁶¹ to Z⁶⁶ and Q⁶,

w and z, independently of one another, are 1 or 2, and

u, v, x and y, independently of one another, are an integer from 0 to 5.

For n, m, o, p, q, r, s, t, u and/or v>1 here, the meanings of the atoms Z¹¹, Z¹² Z¹⁶, Z¹⁷, Z²¹, Z²², Z²⁶, Z²⁷ in the formula (I), Z³¹, Z³², Z³⁴, Z³⁵, Z⁴¹, Z⁴², Z⁴⁴, Z⁴⁵ in the formula (II) and Z⁵¹, Z⁵², Z⁵⁴ and Z⁵⁵ in the formula (III) may be different in the individual recurring units.

Thus, for example, —[—Z¹¹═=Z¹²—]ₙ—, where n=2, can be p-phenylene, as shown by the following formula:

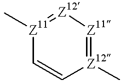

If the substances of the formulae (I), (II) or (III) as positive or negative excess charges depending on the meanings of X¹ to X⁵ and Y¹ to Y⁵, colorless anions X⁻ or cations M⁺ are preferably assigned to them in corresponding number.

The hetero atoms are preferably O, S and N. These anions X⁻ or cations M⁺ are generally redox-inert. This means that their redox potentials are outside the range in which the potentials of the electrochromic substances lie, i.e. outside the range from −1 to +1 V, preferably from −1.5 to +1.5 V. However, they may also be redox-active within this range, provided that their oxidation reduction is fully reversible and does not lead to by-products. For example, they should have at least one reversible reduction or oxidation step in the cyclic voltammogramme, measured in the solvent of the electrochromic medium. Such anions or cations can also take on the role of an RED₁ or OX₂. Examples of such redox-active anions are I⁻, I₃⁻, Br⁻, SCN⁻, [Fe(CN)₆]^{3-/4-}, [Co(CN)₆]^{3-/4-}, Fe[Fe(CN)₆]^{0/1-}. Examples of redox-active cations are all metal salts which occur in at least two oxidation states, such as Fe³⁺/Fe²⁺, Cu²⁺/Cu+, Ni³⁺/Ni²⁺, Co³⁺/Co²+and [Fe(cyclopentadienyl)₂]^{0/+}.

The term substituents here is taken to mean hydrogen or other monovalent organic radicals, for example halogen, alkyl, cycloalkyl, aryl, heteroaryl, hydroxyl, amino, cyano, nitro, —OR¹, —SR¹, —NHR¹, —NR¹₂, —COOR¹, —CONHR¹, —CONR¹₂, —NHCOR¹, —NHSO₂R¹, —NR¹COR¹, —NR¹SO₂R¹, in which R¹ is alkyl, cycloalkyl, aryl or heteroaryl. All these radicals, such as alkyl, cycloalkyl, aryl or heteroaryl, can carry at least one of the abovementioned radicals. However, these substituents can also be part of a two- or multimembered bridge. These bridges may be restricted to one or both sub-systems of the formulae (I), (II) and/or (III). In any case, one substituent in each of the two sub-systems of the formulae (I), (II) and/or (III) is a bond to the bridge B.

This bridge B is formed in the formula (I) between one of the atoms in the group X¹, Z¹¹ to Z¹³, Z¹⁵ to Z¹⁷ and Y¹ and one of the atoms in the group X², Z²¹ to Z²³, Z²⁵ to Z²⁷ and Y² and/or in the formula (II) between one of the atoms in the group X³, Z³¹, Z³², Z³⁴, Z³⁵ and Y³ and one of the atoms in the group X⁴, Z⁴¹, Z⁴², Z⁴⁴, Z⁴⁵ and Y⁴ and/or in the formula (III) between one of the atoms in the group X⁵, Z⁵¹ to Z⁵⁶ or Q⁵ and one of the atoms in the group X⁶, Z⁶¹ to Z⁶⁶ or Q⁶.

The term bridge B here is taken to mean a direct bond or, for example, one of the following groups: —(CH₂)ₐ—, —CH═CH—CH═CH—, o-phenylene, —CH═CH—o—C₆H₄—, —(CH₂)_{b}—o—, m- or p-C₆H₄—(CH₂)_{c}—, —(CH₂)_{b}—O— (CH₂)_{c}—, —(CH₂)_{b}—NH—(CH₂)_{c}—, where these bridges may also be substituted by substituents, as described in greater detail above, and a, b and c, independently of one another, are an integer from 1 to 10, and b and/or c may additionally be 0.

It is also possible for a plurality of units of the formulae (I) to (III) to be linked via such bridges B, forming oligomeric or polymeric electrochromic compounds.

Preference is given to bridges B between the two sub-systems of the formulae (I) or (II) which result, together with the bridge Z¹⁴-Z²⁴ or Z³³-Z⁴³, in the formation of a six-membered ring. Preference is likewise given to a bridge B in the formula (III) formed between one of the atoms in the group Z⁵⁴ to Z⁵⁶ and Q⁵ and one of the atoms in the group Z⁶⁴ to Z⁶6 and Q⁶, where the corresponding atom Z⁵⁴, Z⁵⁵, Z⁵⁶, Z⁶⁴, Z⁶⁵ or Z⁶⁶ must be C.

Preference is consequently also given to electrochromic devices, characterized in that at least one atom X¹ to X⁶, Y¹ to Y⁶ or Q⁵ or Q⁶ in the meaning N or P is a constituent of a heterocyclic ring.

Such heterocyclic rings are aromatic, quasi-aromatic or partially hydrogenated heterocyclic rings, for example pyridine, quinoline, isoquinoline, acridine, pyrylium, thiopyrylium, pyrrole, indole, isoindole, indolizine, indoline, imidazole, benzimidazole, oxazole, benzoxazole, thiazole, benzothiazole, isothiazole, selenazole, benzoselenazole, pyrazole, thiadiazole, triazole and the partially hydrogenated forms thereof, where these rings may carry substituents, as defined above.

Particular preference is given to electrochromic devices, characterized in that, in the formula (I) and/or (II) and/or (III), in each case the pairs X¹ and X², X³ and X⁴, X⁵ and X⁶, Y¹ and Y², Y³ and Y⁴, Y⁵ and X⁶, Z¹¹ and Z²¹, Z¹² and Z²², Z¹³ and Z²³, Z¹⁴ and Z²⁴, Z¹⁵ and Z²⁵, Z¹⁶ and Z²⁶, Z¹⁷ and Z²⁷, Z³¹ and Z⁴¹, Z³² and Z⁴², Z³³ and Z⁴³, Z³⁴ and Z⁴⁴, Z³⁵ d Z⁴⁵, Z⁵¹ and Z⁶¹, Z⁵² and Z⁶², Z⁵³ and Z⁶³, Z⁵⁴ and Z⁶⁴, Z⁵⁵ and Z⁶⁵, Z⁵⁶ and Z⁶⁶, Q⁵ and Q⁶, n and o, m and p, q and s, r and t, u and x, v and y, w and z are identical.

The invention relates to electrochromic devices, characterized in that the methine dyes formed through oxidative or reductive bond breaking or bond formation belong to one of the following classes: streptocyanines, ohemicyanines, phenylogous hemicyanines, cyanines, oxonols, betaines, neutromethines, phenazines, oxazines, thiazines, bisazines, optionally bridged diphenylmethanes, optionally bridged triphenylmethanes, (mono- or di)phenyl(mono- or di)heteroarylmethanes, triheteroarylmethanes, acridines, xanthenes and thioxanthenes. Preference is given to cationic methine dyes. Particular preference is given to hemicyanines, phenylogous hemicyanines, cyanines, optionally bridged diphenylmethanes, optionally bridged triphenylmethanes, (mono- or di)phenyl(mono- or di)heteroarylmethanes and triheteroarylmethanes.

The definition of this class of dyes is taken from R. Raue, Azine Dyes in Ullmann's Encyclopedia of Industrial Chemistry, ₅th edition, Vol. A3, page 213-238 (1985); R. Raue, Methine Dyes and Pigments in Ullmann's Encyclopedia of Industrial Chemistry, ₅th edition, Vol. A16, page 387-534 (1990) and Th. Gessner, U. Mayer, Triarylmethane and Diarylmethane Dyes in Ullmann's Encyclopedia of Industrial Chemistry, ₅th edition, Vol. A27, page 179-227 (1996). Numerous examples of such dyes are also listed therein, which illustrate which methine dyes can form in the sense of the invention through bond breaking or bond formation. In the case that the two subsystems in the formula (I) and/or (II) or two formulae (III) are linked to one another by at least one of the above-defined bridges, the methine dyes formed after oxidative or reductive breaking or formation of a σ-bond are likewise linked to one another via this (these) bridge(s). In the illustrative dyes in the references just cited, such bridges must then be attacked at a suitable point with replacement of a hydrogen or another substituent. The coloring system of the dye is not affected or only insignificantly affected by this.

For the purpose of the invention, particular preference is given to electrochromic devices which comprise, as OX₂ of the formula (I), for example a compound which, after reductive breaking of the σ-bond, converts into a methine dye of the formulae

[chemical structure]

Particular preference is likewise given for the purposes of the invention to electrochromic devices which comprise, as RED₁ of the formula (II), for example a compound which, after oxidative breaking of the σ-bond, converts into a methine dye of the formulae

[chemical structure]

Particular preference is likewise given for the purposes of the invention to electrochromic devices which comprise, as RED₁ of the formula (III), for example a compound which, after oxidative formation of the σ-bond, converts into a methine dye of the formulae

[chemical structure]

The position of the bridge B in the above formulae is random. It is intended only to indicate that the two moieties are bridged. The points of attack of the bridge B in the two moieties are defined more precisely above.

The formulae (CC) to (CCXII) are also taken to mean the corresponding vinylogs and/or phenylogs, and the methine chain may contain N, i.e., for example, formula (CCIII) can also be

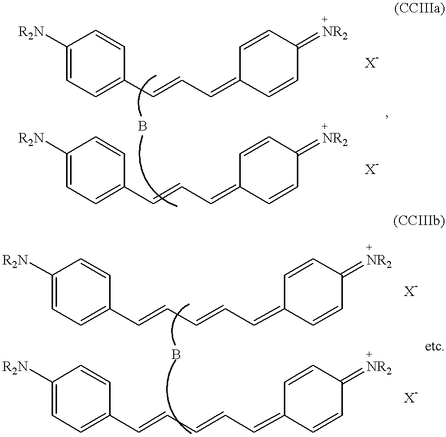

and formula (CCV) can also be

[chemical structure]

The aromatic and quinoid rings may be fused and/or substituted by the radicals mentioned above, for example

[chemical structure]

are radicals of aromatic or quasi-aromatic heterocyclic rings, for example pyridine, quinoline, isoquinoline, acridine, pyrylium, thiopyrylium, pyrrole, indole, isoindole, indolizine, indoline, imidazole, benzimidazole, oxazole, benzoxazole, thiazole, benzothiazole, isothiazole, selenazole, benzoselenazole, pyrazole, thiadiazole or triazole. R is a radical such as alkyl, cycloalkyl, aralkyl or aryl.

Electochromic compounds OX₂ of the formula (I) which result in the methine dyes of the formulae (CC) to (CCII) mentioned are then, for example, the following ((C) to (CII)):

[chemical structure]

Electrochromic compounds RED₁ of the formula (II) which result in the methine dyes of the formulae (CCIII) to (CCX) mentioned are then, for example, the following ((CII) to (CXI)):

[chemical structure]

Electrochromic compounds RED₁ of the formula (III) which result in the methine dyes of the formulae (CCXI) to (CCXII) mentioned are then, for example, the following ((CXII) to (CXIII)):

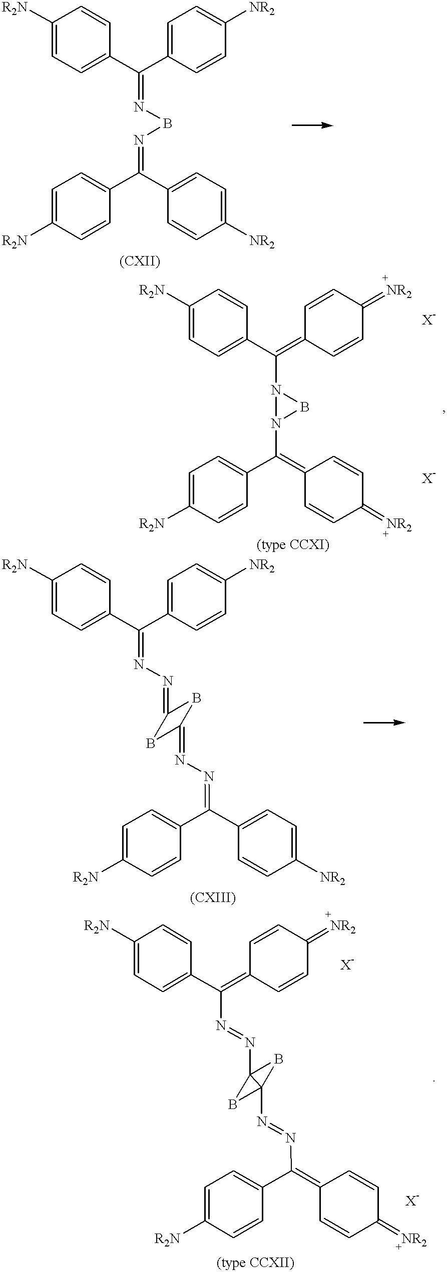

B is one of the bridges described in greater detail above.

Besides these redox substances of the formulae (I), (II) and (III) according to the invention, the electrochromic medium may additionally also comprise all other known electrochromic substances, namely a further redox substance RED₁ or OX₂ is present if only one redox substance of the formula (I), (II) or (III) is present in the electrochromic medium. Such redox substances are known, for example, from U.S. Pat. No. 4,902,108, WO 97/30134, WO 97/30135 and K. Deuchert, S. Hünig, Angew. Chem. 90, 927-938 (1978) and S. Hünig, H. Berneth, Topics in Current Chemistry 92, 1-44 (1980), or can be prepared analogously. Likewise suitable are metal salts or metal complexes, preferably of metals whose oxidation states differ by 1, for example Fe(C₅H₅)₂^{0/+}, Fe₄[Fe(CN)₆]₃ ^{0/4-}, Lu(Pc)^{2+ to 2-} (PC=phthalocyanine), Fe[Fe(CN)₆]^{0/1-}. Likewise suitable redox substances are the redox-active anions X⁻ and/or cations M⁺ already mentioned above. It is also possible to employ mixtures of such redox substances.

The mixing ratios are variable within broad limits. They allow optimization of the desired hue or degree of blackness and/or the optimization of the desired dynamics of the device.

The invention likewise relates to an electrochromic compound in which two identical or different coloring units are linked via at least one bridge in such a way that, on oxidation or reduction, a σ-bond is formed or broken between the two units with a color change of the respective compound.

This is an electrochromic compound RED₁ or OX₂ whose two redox states, which interconvert through the formation or breaking of a σ-bond, have absorption maxima which differ by at least 70 nm, preferably by at least 100 nm, at least one of the absorption maxima being in the visible part of the spectrum.

The redox state of the electrochromic compound RED₁ or OX₂ that absorbs at long wavelength exists either with the σ-bond open or closed, it being possible to produce this redox state which absorbs at long wavelength either by reduction or by oxidation.

The electrochromic compound described above is preferably one which conforms to one of the redox states of the following types

Type A:

[chemical structure]

in which

the units V═Z—W and X═Z—Y which absorb at long wavelength represent methine dyes and

B represents a bridge.

The electrochromic compound particularly preferably conforms to the formula (I)

[chemical structure]

in which

X¹, X², Y¹ and Y², independently of one another, are a hetero atom, such as N, O, S, Se or P, which, in the case of O, S and Se, may also carry a substituent and is then positively charged and in the case of N and P may also carry two substituents and in the second case is positively charged,

Z¹¹ to Z¹⁷ and Z²¹ to Z²⁷, independently of one another, are C, which also carries a substituent, or N,

B is a bridge formed between one of the atoms in the group X¹, Z¹¹ to Z¹³, Z¹⁵ to Z¹⁷ and Y¹, and one of the atoms in group X², Z²¹ to Z²³, Z²⁵ to Z²⁷ and Y², and

n, m, o and p, independently of one another, are an integer from 0 to 5.

The electrochromic compound likewise preferably conforms to the formula (II)

[chemical structure]

in which

X³, X⁴, Y³ and Y⁴, independently of one another, are a hetero atom, such as N, O, S, Se or P, which, in the case of O, S and Se, also carries a substituent or a negative charge and in the case of N and P also carries two substituents,

Z³¹ to Z³⁵ and Z⁴¹ to Z⁴⁵, independently of one another, are C, which also carries a substituent, or N,

B is a bridge formed between one of the atoms in the group X³, Z³¹, Z³², Z³⁴, Z³⁵ and Y³ and one of the atoms in the group X⁴, Z⁴¹, Z⁴², Z⁴⁴, Z⁴⁵ and Y⁴, and

q, r, s and t, independently of one another, are an integer from 0 to 5, with the restriction that it is not simultaneously the case that

X³, X⁴, Y³ and Y⁴ are dimethylamino or methoxy or X³-X⁴ and/or Y³-Y⁴ are a bridge of the formula —O—,

(Z³¹═Z³²)_{q}, (Z⁴¹═Z⁴²)ₛ, (Z³⁴═Z³⁵)ᵣ and (Z⁴⁴═Z⁴⁵)ₜ are o- or p-phenylene, Z³³-Z⁴³ are a tetravalent radical of the formula

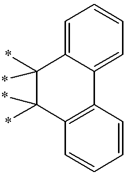

in which the bonds denoted by asterisks (*)are the linking points.

The electrochromic compound likewise preferably conforms to the formula (III)

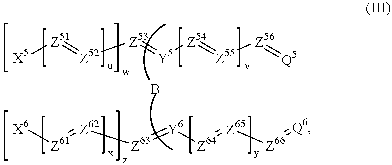

in which

X⁵ and X⁶, independently of one another, are a hetero atom, such as N, O, S, Se or P, which, in the case of O, S and Se, also carries a substituent or a negative charge and in the case of N and P also carries two substituents,

Y⁵ and Y⁶, independently of one another, are a hetero atom, such as N or P, or C, which also carries a substituent,

Q⁵ and Q⁶, independently of one another, are a hetero atom, such as N or P, which also carry a substituent, or C, which also carries two substituents,

Z⁵¹, Z⁵², Z⁵⁴ to Z⁵⁶ and Z⁶¹, Z⁶², Z⁶⁴ to Z⁶⁶, independently of one another, are C, which also carries a substituent, or N,

Z⁵³ to Z⁶³ are C, which also carries a substituent if w or z is 1,

B is a bridge formed between one of the atoms in the group X⁵, Z⁵¹ to Z⁵⁶ and Q⁵ and one of the atoms in the group X⁶, Z⁶¹ to Z⁶⁶ and Q⁶,

w and z, independently of one another, are 1 or 2, and

u, v, x and y, independently of one another, are an integer from 0 to 5.

The term bridge B here is taken to mean a direct bond or, for example, one of the following groups: —(CH₂)ₐ—, —CH═CH—CH═CH—, o-phenylene, —CH═CH—o—C₆H₄—, —(CH₂)_{b}—o—, m- or p-C₆H₄—(CH₂)_{c}—, —(CH₂)_{b}—O—(CH₂)_{c}—, —(CH₂)_{b}—NH—(CH₂)_{c}—, where these bridges may also be substituted by substituents, as described in greater detail above, and a, b and c, independently of one another, are an integer from 1 to 10, and b and/or c may additionally be 0.

The bridge B, which is formed by the substituents of two atoms in the groups X, Y, Z or Q, is particularly preferably a six-membered ring. Angew. Chem. 109,1387 (1997) and Chem. Commun. 1998, 2193, disclose electrochromic compounds which fall under the formula (II). However, the use for electrochromic devices is not described.

In the substituent definitions given above, alkyl radicals, including derivatives, such as, for example, alkoxy or aralkyl radicals, are preferably those having 1 to 12 C atoms, in particular having 1 to 8 C atoms, unless stated otherwise. They can be straight-chain or branched and can optionally carry further substituents, such as C₁- to C₄-alkoxy, fluorine, chlorine, hydroxyl, cyano, C₁- to C₄-alkoxycarbonyl or COOH.

The term cycloalkyl radicals is preferably taken to mean those having 3 to 7 carbon atoms, in particular having 5 or 6 carbon atoms.

Alkenyl radicals are preferably those having from 2 to 8 carbon atoms, in particular 2 to 4 carbon atoms.

Aryl radicals, including those in aralkyl radicals, are phenyl or naphthyl radicals, in particular phenyl radicals. They can be substituted by 1 to 3 of the following radicals: C₁- to C₆-alkyl, C₁- to C₆-alkoxy, fluorine, chlorine, bromine, cyano, hydroxyl, C₁- to C₆-alkoxycarbonyl or nitro. Two adjacent radicals can also form a ring.

The term optionally benzo-fused aromatic or quasi-aromatic, five- or six-membered heterocyclic rings is taken to mean, in particular, imidazole, benzimidazole, oxazole, benzoxazole, thiazole, benzothiazole, indole, pyrazole, triazole, thiophene, isothiazole, benzisothiazole, 1,3,4- or 1,2,4-thiadiazole, pyridine, quinoline, pyrimidine and pyrazine. They may be substituted by 1 to 3 of the following radicals: C₁- to C₆-alkyl, C₁- to C₆-alkoxy, fluorine, chlorine, bromine, cyano, nitro, hydroxyl, mono- or di-C₁-to C₆-alkylamino, C₁- to C₆-alkoxycarbonyl, C₁- to C₆-alkylsulfonyl, C₁- to C₆-alkanoylamino, phenyl or naphthyl. Two adjacent radicals may also form a ring.

The invention furthermore relates to a process for the preparation of the electrochromic substances of the formulae (I), (II) and (III) according to the invention. Further details in this respect are given in the examples.

The electrochromic medium according to the invention preferably comprises at least one solvent in which the electrochromic substances, if used a conductive salt and if used further additives are dissolved. The solvent can also have been thickened in the form of a gel, for example by polyelectrolytes, porous solids or nanoparticles having large active surface areas.

Suitable solvents are all solvents which are redox-inert under the selected voltages and which cannot eliminate electrophiles or nucleophiles or themselves react as sufficiently strong electrophiles or nucleophiles and thus could react with the colored free-radical ions. Examples are propylene carbonate, γ-butyrolactone, acetonitrile, propionitrile, glutaronitrile, methylglutaronitrile, 3,3′-oxydipropionitrile, hydroxypropionitrile, dimethylformamide, N-methylpyrrolidone, sulpholane, 3-methylsulpholane or mixtures thereof. Preference is given to propylene carbonate and mixtures thereof with glutaronitrile or 3-methylsulpholane.

In the case of oligomeric or polymeric electrochromic compounds which can be built up by bridging a plurality of units of the formulae (I) to (III), as described above, it is also possible to omit the solvent. The compounds are then employed, for example, in the form of films.

The electrochromic medium according to the invention or the electrochromic solution according to the invention can contain at least one inert conductive salt. In particular if at least one of the substances of the redox pair RED,/OX₂ is of an ionic nature, the addition of a conductive salt can be omitted.

Suitable inert conductive salts are lithium, sodium and tetraalkylammonium salts, in particular the latter. The alkyl groups can contain between 1 and 18 carbon atoms and can be identical or different. Preference is given to tetrabutylammonium. Suitable anions for these salts, but also as anions X- in charge-carrying electrochromic substances of the formulae (I) to (III), are all redox-inert, colorless anions.

Examples are tetrafluoroborate, tetraphenylborate, cyanotriphenylborate, tetramethoxyborate, tetrapropoxyborate, tetraphenoxyborate, perchlorate, chloride, nitrate, sulphate, phosphate, methanesulphonate, ethanesulphonate, tetradecanesulphonate, pentadecanesulphonate, trifluoromethanesulphonate, perfluorobutanesulphonate, perfluorooctanesulphonate, benzenesuiphonate, chlorobenzene-sulphonate, toluenesulphonate, butylbenzenesulphonate, tert-butylbenzenesulphonate, dodecylbenzenesulphonate, trifluoromethylbenzenesulphonate, hexafluorophosphate, hexafluoro-arsenate, hexafluorosilicate, 7,8- or 7,9-dicarbanidoundecaborate(−1) or (−2), which are optionally substituted on the B and/or C atoms by one or two methyl, ethyl, butyl or phenyl groups, dodecahydrodicarbadodecaborate(−2) or B-methyl-C-phenyidodecahydrodicarbadodecaborate(−1).

The conductive salts are preferably employed in the range from 0 to 1 mol/l. Further additives which can be employed are thickeners in order to control the viscosity of the electro-active solution. This can be of importance for avoiding segregation, i.e. the formation of colored streaks or spots on extended operation of the electrochromic device in the switched-on state, and for controlling the fading rate after the current is switched off.

Suitable thickeners are all compounds usual for this purpose, such as, for example, polyacrylate, polymethacrylate (Luctite L®), polycarbonate or polyurethane.

Suitable further additives for the electrochromic medium are UV absorbers. Examples are UVINUL® 3000 (2,4-dihydroxybenzophenone, BASF), SANDUVOR® 3035 (2-hydroxy-4-n-octyloxybenzophenone, Clariant), Tinuvin® 571 (2-(2H-benzotriazol-2-yl)-6-dodecyl-4-methylphenol, Ciba), Cyasorb ₂₄™ (2,2′-dihydroxy-4-methoxy-benzophenone, American Cyanamid Company), UVINUL® 3035 (ethyl 2-cyano-3,3-diphenylacrylate, BASF), UVINUL® 3039 (2-ethylhexyl 2-cyano-3,3-diphenylacrylate, BASF), UVINUL® 3088 (2-ethylhexyl p-methoxycinnamate, BASF), CHIMASSORB® 90 (2-hydroxy-4-methoxy-benzophenone, Ciba), and SANDUVOR® PR-25 (dimethyl 4-methoxybenzylidenemalonate, Clariant).

Preference is given to the five last-mentioned compounds. Preference is likewise given to mixtures of UV absorbers, for example of the four last-mentioned compounds. Preference is given to the mixture of UVINUL® 3039 and CHIMASSORB® 90.

Further additives can be yellow filters, such as, for example,

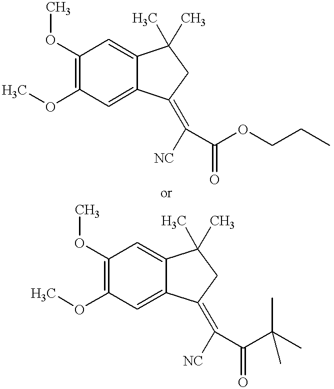

The UV absorbers or yellow filters are employed in the range from 0.01 to 2 mol/l, preferably from 0.04 to 1 mol/l.

The electrochromic medium contains the electrochromic substances OX₂ and RED₁, in particular those of the formulae (I) to (III), in each case in a concentration of at least 10⁻⁴ mol/l, preferably from 0.001 to 0.5 mol/l. The total concentration of all electrochromic substances present is preferably less than 1 mol/l.

In order to operate the electrochromic device according to the invention, a constant, pulsed or amplitude-variable, for example sinus-rectangularly or triangularly-variable, direct voltage is used.

However, it is also possible to use alternating voltage, i.e. a voltage whose polarity changes at a certain frequency. This voltage change can take place in rectangular form, triangular form, sinusoidal form or in any desired other form. In particular, the phases of opposite polarity can have different lengths.

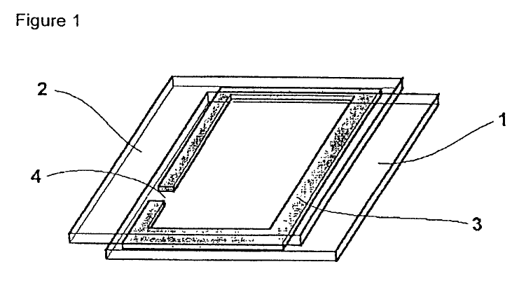

The frequency of the alternating voltage or of the pulsed or amplitude-variable direct voltage can be in the range from 10-2 to 104 Hz, preferably from 10-1 to 103 Hz, particularly preferably from 10 to 5×10² Hz. The frequency can also be variable during operation. A particularly preferred form of frequency-variable alternating voltage is the rectangular alternating voltage shown in FIG. 1, and derivatives thereof with the same frequency sequence, but with a triangular or sinusoidal course.

The amplitude of the applied voltage depends on the desired color depth and on the reduction or oxidation potentials of the OX₂ and RED₁ used. The difference between the reduction and oxidation potentials is a guide value for the requisite voltage, but the electrochromic device can be operated at lower or even at higher voltage.

If the voltage is switched off, the electrochromic device according to the invention becomes colorless again. This erasing can be accelerated if the contacted segments or plates are short-circuited. The display can also be erased very rapidly by repeated reversal of the voltage, optionally also with simultaneous reduction in the voltage.

By varying the layer thickness of the electrochromic device, the viscosity of the electrochromic solution and/or by selecting electrochromic substances with respect to their diffusibility or driftability, the switch-on and switch-off times of the display device can be modified within broad limits. Thus, for example, thin layers exhibit shorter switching times than thick ones. The size of the molecules of the electrochromic medium, in particular in the systems bridged by B or in the oligomeric or polymeric systems, influences the diffusibility or driftability. The larger the molecules, the lower their diffusibility or driftability. The charge state of the molecules also affects the driftability. The higher the charge for the same molecular size, the greater the drift rate. It is thus possible to construct fast- and slow-switchable devices which are optimally matched to the respective applications.

The device can be operated in power-saving or refresh mode. In power-saving or refresh mode, the direct voltage or alternating voltage applied to the device is continually interrupted. In the voltage-free phases, the contacts of the device are not conductively connected to one another. The phases with voltage and the voltage-free phases alternate and can be of the same or different duration. In the preferred operating form, the phases in which voltage is applied are shorter than the phases without voltage. The ratio can be between 1:1.5 to 1:30, preferably between 1:2 and 1:10. The absolute duration of the phases can be very different and depends essentially on the design of the device. With increasing viscosity of the electrochromic medium and/or layer thicknesses of the device, the absolute duration of the phases can increase. At layer thicknesses of from 100 to 400 μm, the phase duration can be in the range from 0.5 to 20 seconds. In the case of a low-viscosity electrochromic medium and/or at low layer thicknesses of the device, for example from 5 to 50 μm, the absolute duration can be less than one second, for example from 0.001 to 0.5 second, preferably from 0.01 to 0.1 second. Due to the voltage-free and thus current-free phases, considerable amounts of electrical current are saved, depending on the ratio of the phase lengths. At a ratio of 1:9, for example, 90% of the current are saved compared with continuous operation. Due to the design of the device and the absolute phase length matched thereto, a variation of flickering of the intensity of the switched-on electrochromic device or its segments or pixels and unsharpness of the segments or pixels due to diffusion during the voltage-free phases is avoided.

Specific embodiments of the electrochromic device according to the invention may be, for example, the following, which are likewise a subject-matter of the invention. A distinction is made here between two basic types:

Type 1: full-area electrochromic device.

Type 2: electrochromic display devices with structured electrodes.

Type 1: (non-mirrored): from the light protection/light filter area: window panes for, for example, buildings, road vehicles, aircraft, railways, ships, roof glazing, automobile sunroofs, glazing of greenhouses and conservatories, light filters of any desired type.

From the security/confidentiality area: separating panes for, for example, room dividers in, for example, offices, road vehicles, aircraft, railways, sight protection screens at, for example, bank counters, door glazing, visors for, for example, motorcycle or pilot helmets.

From the design area: glazing of ovens, microwave equipment, other domestic appliances, furniture. From the display area: voltmeters, for example battery testers, tank displays, tachometers.

Type 1: (mirrored): Mirrors of all types, for example for road vehicles, railways, in particular planar, spherical, aspherical mirrors and combinations thereof, for example spherical/aspherical, mirror glazing in furniture.

Type 2: Display devices of all types, for example segment or matrix displays, for example for watches, computers, electrical equipment, electronic equipment, such as radios, amplifiers, TV sets, CD players, etc., destination displays in buses and trains, departure displays in stations and airports, flat panel screens, all applications mentioned under type 1 which contain at least one switchable static or variable display device, for example separating screens containing displays such as, for example, “Please do not disturb”, “Counter closed”, for example automobile mirrors containing displays of any desired type, such as display of the temperature, faults in the vehicle (for example oil temperature, open doors), time, compass direction.

### EXAMPLES

### Example 1

a) 8.2 g of o-xylylene dibromide and 5.6 g of γ-picoline were stirred at 80° C. for 2 hours in 60 ml of γ-butyrolactone. After cooling, the solid was filtered off with suction, washed with 3×10 ml of γ-butyrolactone and dried at 50° C. under reduced pressure, giving 11.6 g (86% of theory) of a white powder of the formula

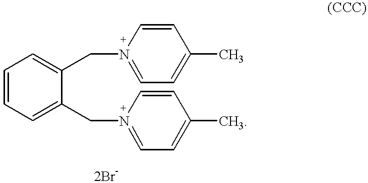

b) 9.0 g of this product were introduced into 20 g of glacial acetic acid. 20 ml of piperidine were added dropwise with cooling. 7.1 g of 4-diethylaminobenzaldehyde were finally scattered in. The mixture was stirred at 80° C. for 2 hours, cooled and discharged into 350 ml of water. After the mixture had been stirred at room temperature for 2 hours, the solid was filtered off with suction, washed with 50 ml of water and dried at 50° C. under reduced pressure, giving 11.5 g (75% of theory) of a deep-red powder of the dye of the formula

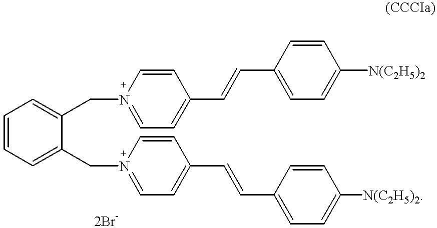

¹H-NMR ([D₆]-DMSO): δ=1.12 (t), 3.42 (q), 5.96 (s), 6.73 (d), 7.16 (d), 7.27 (m), 7.53 (m), 7.56 (d), 7.96 (d), 8.08 (d), 8.74 (d).

c) 7.7 g of this bromide were dissolved in 170 ml of methanol. 13.2 g of tetrabutylammonium tetrafluoroborate were added at the boiling point. After the mixture had boiled for 15 minutes, it was cooled, and the solid was filtered off with suction, washed with 3×10 ml of methanol and dried at 40° C. under reduced pressure, giving 5.8 g (74% of theory) of a deep-red, blue-shimmering powder of the formula

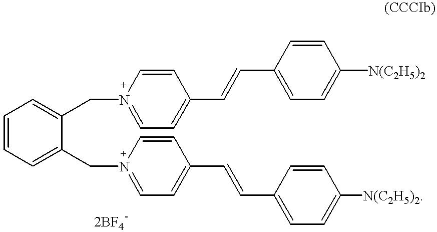

### Example 2

a) A mixture of 3.44 g of tetraethyl butane-1,1,4,4-tetracarboxylate and 6.25 g of 2-mercaptoanilin were heated at from 80 to 90° C. for 2 hours, at 120° C. for 3 hours and finally at 140° C. for 1 hour in 100 ml of polyphosphoric acid. The mixture was cooled to 80° C. and stirred into 200 ml of cooled water. The precipitate was filtered off and washed with semisaturated potassium carbonate solution. The residue was subsequently recrystallized from dimethyl sulphoxide, and the crystalline product was washed with ethanol, giving 1.71 g (29% of theory) of a pale-yellow crystalline solid of the formula

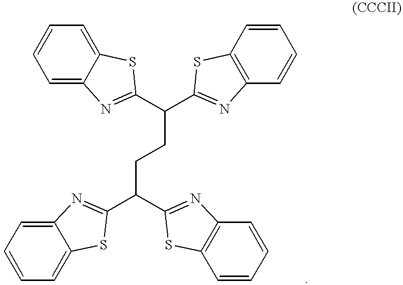

m.p. 248-250° C.

¹H-NMR (CDCl₃): δ=2.70 (m), 5.09 (m), 7.33-7.46 (m), 7.79-8.00 (m).

b) 400 mg of this substance were suspended in 8 ml of dichloromethane, and 460 mg of trimethyloxonium tetrafluoroborate were added at 0° C. The mixture was stirred at room temperature for 12 hours. 180 mg of ethyidi(isopropyl)amine were added dropwise, and the mixture was stirred for a further 36 hours. The precipitate was filtered off and recrystallized from acetonitrile, giving 490 mg (89% of theory) of an orange solid of the formula

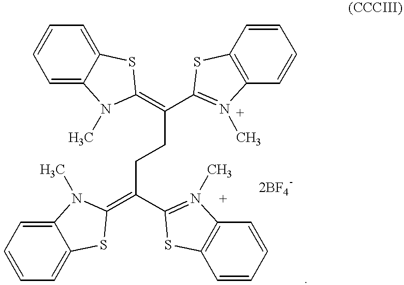

¹H-NMR (CD₃CN): δ=3.22 (s), 3.29 (s), 7.51-7.95 (m).

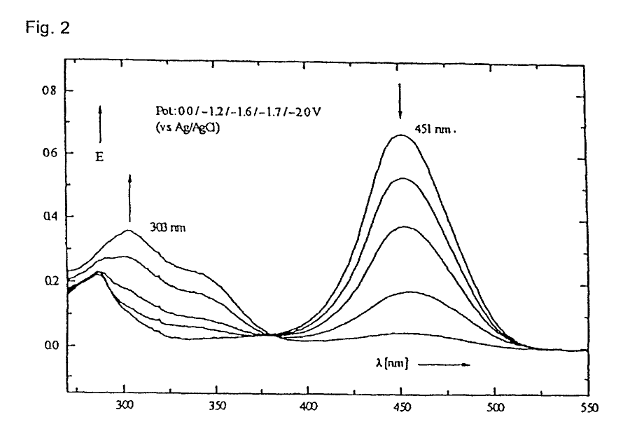

Spectroelectrochemistry (reduction): FIG. 2. Electrochemical compounds which contain a —(CH₂)₃— or —(CH₂)₄-bridge instead of the —CH₂—CH₂-bridge can also be obtained analogously, for example

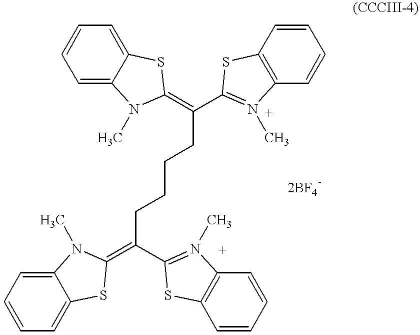

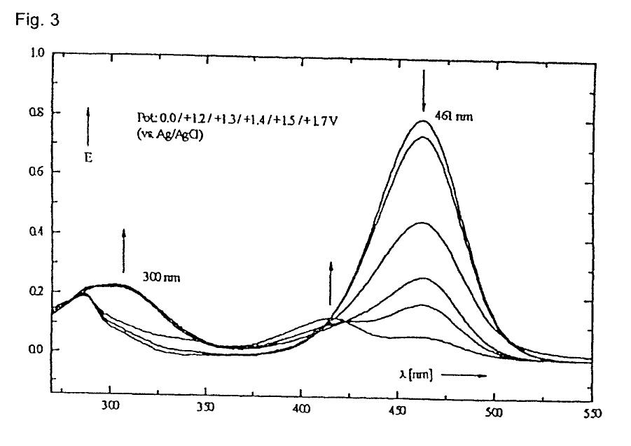

Spectroelectrochemistry (oxidation) of (CCCIII-4): FIG. 3.

### Example 3

a) A suspension of 2.75 g of 2,3-dimethylbenzothiazolium methosulphate in 15 ml of anhydrous pyridine was cooled to 0° C., and 0.91 g of adipoyl dichloride was added dropwise. The mixture was stirred at 0° C. for 30 minutes and subsequently heated at 80° C. for 15 minutes. 15 ml of methanol were added to the hot solution. The precipitate was filtered off and recrystallized from pyridine/methanol, giving 1.12 g (46% of theory) of colorless needles of the formula

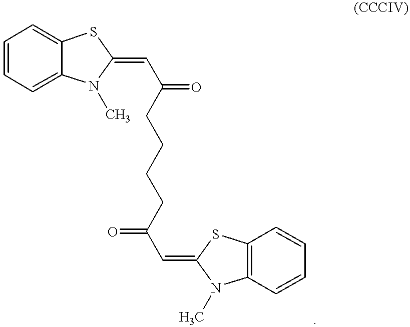

m.p. 218° C.

b) 440 mg of trimethyloxonium tetrafluoroborate were dissolved in 5 ml of dichloromethane, and 436 mg of the compound from a) were added at room temperature. A few drops of ethyidi(isopropyl)amine were added. After the mixture had been stirred at room temperature for 60 minutes, the suspension was filtered with suction, giving 600 mg (94% of theory) of a colorless crystalline solid of the formula

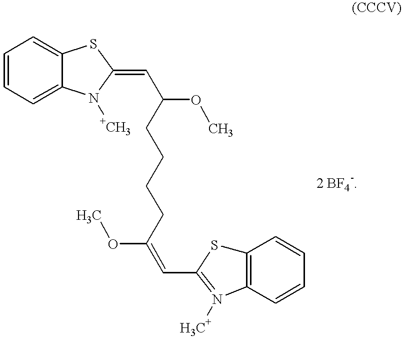

m.p. 235-237° C.

c) 1.5 g of the compound from b) were suspended in 60 ml of methanol, the suspension was warmed to 40° C., and 2.20 g of the compound of the formula

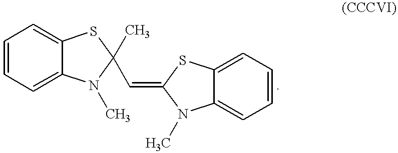

were added. The reaction mixture was refluxed for 3 hours. After the mixture had been cooled to room temperature, the precipitated solid was filtered off. Extraction with isopropanol gave 668 mg of a red by-product and, as residue, 465 mg (23% of theory) of a green-metallically shimmering crystalline solid of the formula

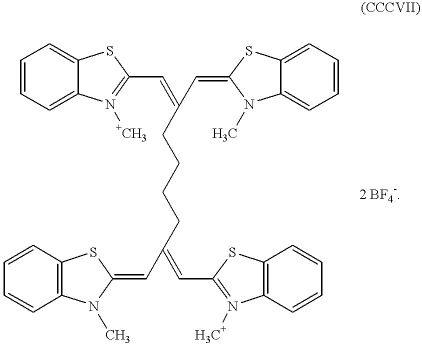

m.p. 295-296° C.

¹H-NMR ([D₆]-DMSO): δ=2.00 (m), 3.03 (m), 3.92 (s), 6.47 (s), 7.34 to 7.90 (m).

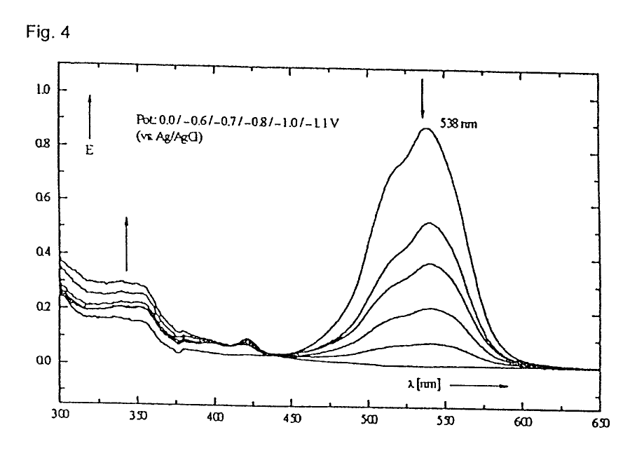

Spectroelectrochemistry (reduction): FIG. 4.

### Example 4

a) 5.22 g of suberic acid were dissolved in 45 ml of tetrahydrofuran, 6.24 g of N-methylmorpholine were added, and the mixture was cooled to −20° C. with stirring. 8.82 g of isobutyl chloroformate and, after 15 minutes, 8.97 g of o-methylaminothiophenol were added.

After 5 minutes, the cooling bath was removed, and the pale-yellow suspension was stirred for 45 minutes. A solution of 25.0 g of ammonium hexafluorophosphate in 50 ml of conc. hydrochloric acid was subsequently added dropwise. The colorless precipitate which formed was washed with ice-water and ether and dried under reduced pressure. Recrystallization with acetonitrile gave 17.7 g (88% of theory) of colorless crystals of the formula

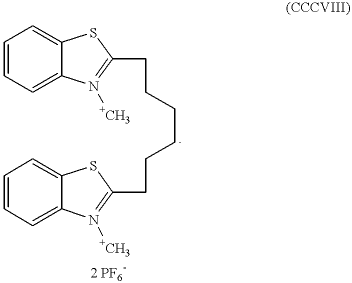

m.p. 252-256° C.

b) 0.50 g of the compound of the formula

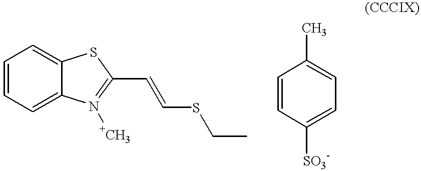

and 0.32 g of the compound from a) were dissolved in 20 ml of pyridine, and the mixture was refluxed for 30 minutes. After the mixture had been cooled, the blue crystalline precipitate which formed was filtered off and recrystallized from acetonitrile, giving 240 mg (48% of theory) of a blue-metallically shimmering solid of the formula

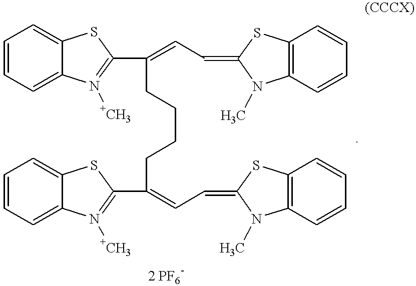

m.p. 284-2855C.

¹H-NMR ([D₆]-DMSO): δ=1.77 (m), 2.79 (m), 3.74 (s), 4.09 (s), 6.17 (d), 7.07-8.06 (m).

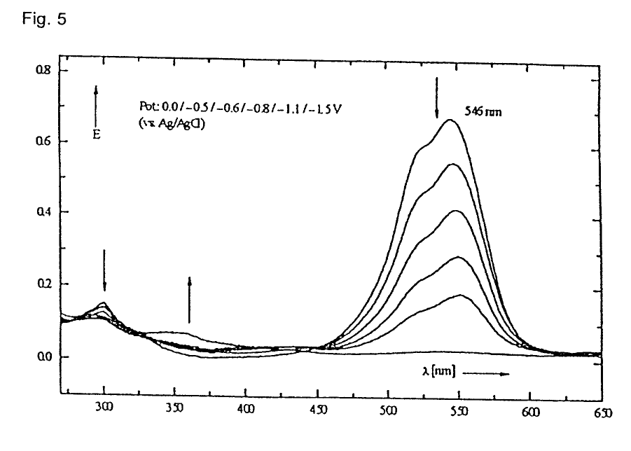

Spectroelectrochemistry (reduction): FIG. 5.

### Example 5

0.50 g of the compound of the formula (CCCVIII) from Example 4a and 0.24 g of 4-dimethylaminobenzaldehyde were suspended in 10 ml of acetic anhydride, and the mixture was refluxed for 30 minutes. The reaction mixture was subsequently added dropwise to a hot solution of 0.65 g of ammonium tetrafluoroborate in 30 ml of water. The precipitate which formed was filtered off with suction and recrystallized from acetonitrile, giving 0.53 g (76% of theory) of a metallically shimmering red solid of the formula

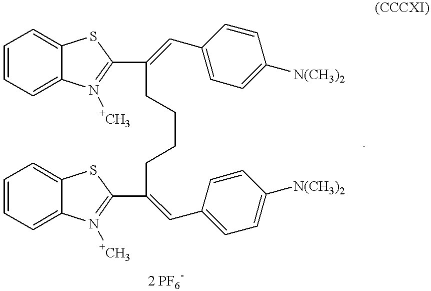

m.p. 158° C.

¹H-NMR ([D₆]-DMSO): δ=1.72 (m), 2.95 (m), 3.00 (s), 4.23 (s), 7.24 (s), 6.75-8.41(m).

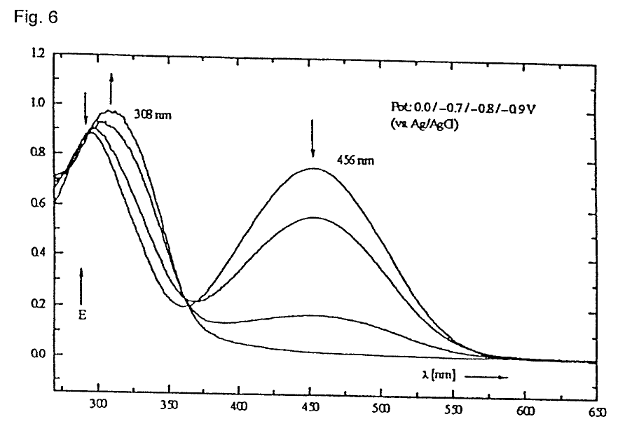

Spectroelectrochemistry (reduction): FIG. 6.

### Example 6

a) A solution of 2.0 g of Michier's ketone and 1.2 g of thionyl chloride in 30 ml of toluene was stirred at from 20 to 25° C. for 3 hours. The solid was then filtered off, digested with 20 ml of toluene, re-filtered and dried under reduced pressure, giving 1.9 g (80% of theory) of dark-blue crystals of the formula

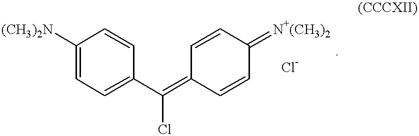

b) A solution of 100 mg of 2,2′-diaminobiphenyl in 2 ml of dichloromethane was added dropwise at 20-25° C. to a solution of 349 mg of the compound of the formula (CCCXII) (from a)) and 275 mg of triethylamine in 20 ml of dichloromethane. The reaction mixture was washed with 2×10 ml of saturated, aqueous sodium hydrogencarbonate solution and 10 ml of saturated, aqueous sodium chloride solution and dried using sodium sulphate. The solvent was distilled off under reduced pressure, giving 320 mg of a red oil. This was digested overnight at 20-25° C. with 10 ml of ethyl acetate/hexane (1:4), during which an orange powder precipitated. The supernatant solution was pipetted off. The residue was digested 3× in the same way with 10 ml of diethylether each time and each time the supernatant solution was pipetted off. Finally, the solid was dried at 50° C. under a reduced pressure of 5×10-2 mmHg, giving 230 mg (65% of theory) of an orange powder of the formula

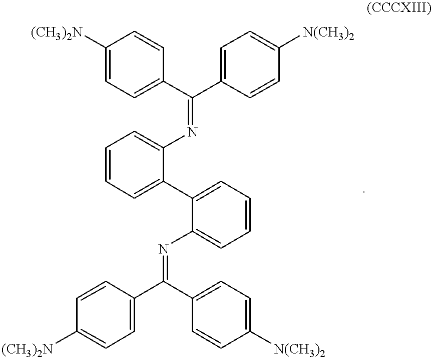

m.p. 254-256° C.

¹H-NMR(600 MHz, CDCl₃): δ=2.86, 2.97 (each s), 6.29, 6.63, 6.77, 7.70 (each d), 6.65, 6.72, 6.95 (each m).

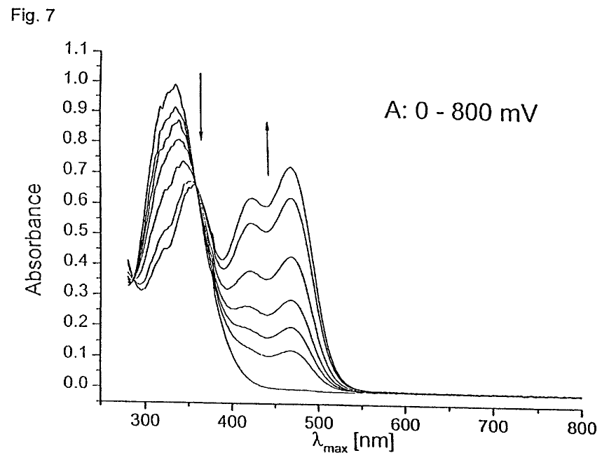

Spectroelectrochemistry (oxidation): FIG. 7.

### Example 7

0.8 g of Michler's ketone hydrazone and 0.2 g of 1,5-cyclooctanedione were stirred for 2 hours at 20-25° C. in 10 ml of dichloromethane in the presence of 10 ml of glacial acetic acid and 50 mg of molecular sieve (4 μm). The molecular sieve was filtered off. The solution was washed rapidly with 10 ml of saturated, aqueous sodium hydrogencarbonate solution and 10 ml of saturated, aqueous sodium chloride solution and dried using sodium sulphate. After the solvent had been distilled off, the highly viscous oil which remained was taken up in 1 ml of ethyl acetate, 10-20 ml of petroleum ether (30-50° C.) were added dropwise with stirring, the mixture was stirred overnight at 20-25° C., and the solid was filtered off, washed with 10 ml of petroleum ether (30-50° C.) and dried at 50° C. under a reduced pressure of 5×10-2 mmHg, giving 0.7 g (73% of theory) of a pale-yellow powder of the formula

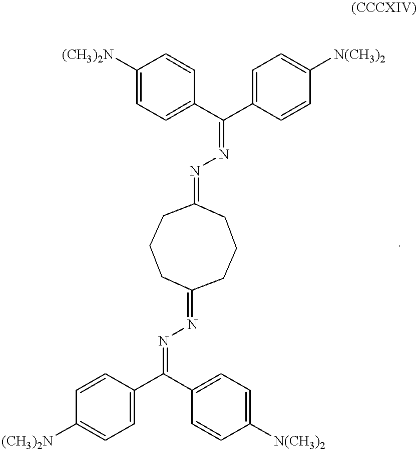

m.p. 209-210° C.

¹H-NMR (CDCl₃): δ=2.05, 2.44, 2.46 (each m), 2.89, 2.96, 2.97, 3.00 (each s), 6.63, 7.22, 7.54, 7.64 (each m).

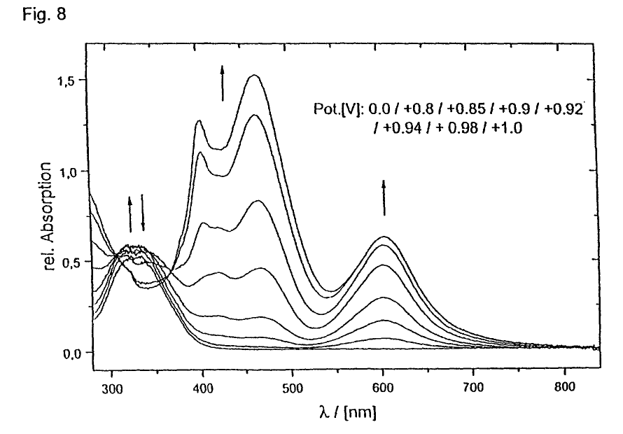

Spectroelectrochemistry (oxidation): FIG. 8.

### Example 8

A cell was constructed as shown in FIG. 1. To this end, two glass plates 1 and 2 coated on one surface with ITO were used.

A mixture of 97% of photocuring DELO-Katiobond® 4594 epoxy adhesive (DELO Industrieklebstoffe, Landsberg) and 3% of glass beads with a diameter of 200 μm were applied in a ring shape 3 to the ITO-coated side of glass plate 1 in such a way that a 2 mm wide opening 4 was left. Glass plate 2 was then placed on the adhesive bead in such a way that the ITO layers of the two plates 1 and 2 were facing one another and a geometry as shown in FIG. 1 was formed. The adhesive was cured by exposure for 10 minutes to daylight in the vicinity of a window and then for 20 minutes at 105° C. without exposure.

A dish was filled under a nitrogen atmosphere with a solution which was 0.002 molar with respect to the electrochromic compound of the formula (CCCIb) from Example 1 and 0.004 molar with respect to the electrochromic compound of the formula

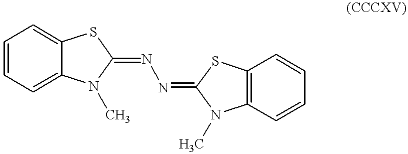

and in 0.1 molar with respect to each of the UV absorbers of the formulae

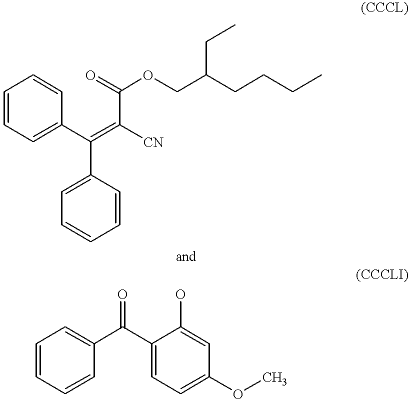

in anhydrous, oxygen-free propylene carbonate.

The cell was then placed vertically in the dish under a nitrogen atmosphere in such a way that the opening 4 was located beneath the liquid level. The dish with cell was placed in a dessicator, which was evacuated to 0.05 mbar and then carefully aerated with nitrogen. During the aeration, the electrochromic solution rose through the opening 4 into the cell and filled the entire volume apart from a small bubble. The cell was removed from the solution, cleaned at the opening 4 under a nitrogen atmosphere by wiping with a paper towel and sealed with the photochemically curable acrylate adhesive DELO-Photobond® 4497 (DELO Industrieklebstoffe, Landsberg). The cell was then exposed for I minute under a nitrogen atmosphere with a DELOLUX® 03 lamp (DELO Industrieklebstoffe, Landsberg) at a distance of 8 cm from the opening 4, and cured at room temperature overnight under a nitrogen atmosphere.

The cell had a bright red color (λₘₐₓ=502 nm, absorbance 2,2). Application of a voltage of 1.6 V to the two plates 1 and 2 caused the cell rapidly to turn a dirty red (λₘₐₓ=410 nm; 502 nm, absorbance=1,8; 650 nm; 735 nm). Switching off the voltage and short-circuiting the contacts caused the bright red color rapidly to disappear again. 5 000 such cycles were withstood without the switching behaviour changing.

### Example 9

A cell was constructed as in Example 8, but the electrochromic compound of the formula (CCCXV) was replaced by ferrocene of the formula

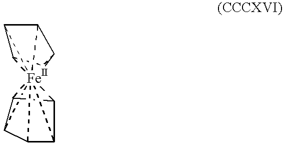

The cell likewise exhibited a bright-red coloration (λₘₐₓ=502 nm, absorbance=2.2). Application of a voltage of 1.4 V to the two plates 1 and 2 caused the cell coloration to become a weaker red (λₘₐₓ=502 nm, absorbance=1.75).

### Examples 10-17

Cells were produced analogously to Examples 8 and 9 but with other electrochemical compounds according to the invention instead of the electrochemical compound of the formula (CCCIb) and containing a reducible or oxidizable 2^{nd} electrochromic compound which is matching in each case. The following cells were obtained:

| | Electrochemical |
|---|---|
| Example | compound |
| 10 | (CCCIII) |
| 11 | (CCCVII) |
| 12 | (CCCIII) |
| 13 | (CCCX) |
| 14 | (CCCXI) |
| 15 | (CCCXIII) |
| 16 | (CCCXIV) |
| 17 | 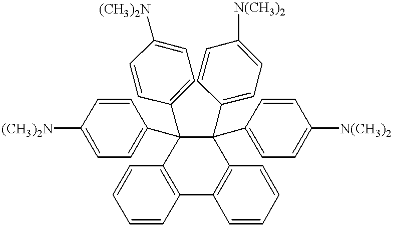 |
| | (CCCXIX) |

| | 2^{nd} electrochromic | | |
|---|---|---|---|
| Example | compound | Color | Voltage |
| 10 | (CCCXVI) | lemon yellow → | 2 V |
| | | pale yellow | |
| 11 | (CCCXVI) | red → pale red | 1.5 V |
| 12 | 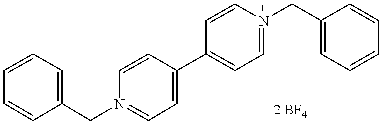 | lemon yellow →yellowish green | 1.5 V |
| | (CCCXVII) | | |
| 13 | (CCCXV) | blue → green | 1.5 V |
| 14 | (CCCXVI) | bright orange → | 1.3 V |
| | | pale orange | |
| 15 | 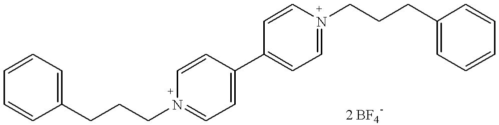 | orange-yellow →olive green | 1.7 V |
| | (CCCXVIII) | | |
| 16 | (CCCXVIII) | pale yellow → | 1.2 V |
| | | green | |
| 17 | (CCCXVII) | colorless → blue | 1.6 V |

Key to the figures:

FIG. 1: Sketch of a cell according to Example 8

FIGS. 2-8: Spectroelectrochemical studies (see J. Salbeck, J. Electroanal. Chem. 1992, 340,169):

Electrochemical apparatus: polished platinum disc electrode (Ø6 mm) as working electrode, platinum counterelectrode and silver wire as reference electrode; solvent acetonitrile or methylene chloride, tetrabutylammonium hexafluorophosphate as conductive salt (0.1 molar).

Spectroscopic measurement: measurement in reflection on the platinum disc electrode with the aid of a waveguide with the Perkin-Elmer Lambda 19 UV spectrometer.

The arrow indicates whether the absorption increases or decreases when the applied voltage is varied in the manner indicated in the figure starting from 0 V.

What is claimed is:

1. An electrochromic device comprising
(a) two plates or films in which the facing sides are provided with an electrically conductive layer, wherein at least one such plate or film is transparent and at least one such conductive layer is transparent,
(b) a sealing ring joining the plates or films such that the volume formed by the two plates or films and the sealing ring is filled with an electrochromic medium comprising at least one reducible compound OX₂ and at least one oxidizable compound RED₁ that converts into their respective redox states RED₂ and OX₁ by taking up electrons at a negative electrode or by releasing electrons at a positive electrode,
wherein, after charge equalization between RED₂ and OX₁, the original redox states OX₂ and RED₁ are in each case re-formed, and
wherein at least one RED₁ or OX₂ is an electrochromic compound in which two identical or different coloring units are connected via at least one bridge in such a way that, on oxidation or reduction, a σ-bond is formed or broken between the two units with a color change of the compound in question.

2. Electrochromic device of claim 1, wherein the two redox states of the electrochromic compound RED₁ and OX₂, which interconvert through the formation or breaking of a σ-bond, have absorption maxima which differ by at least 70 nm, preferably by at least 100 nm, where at least one of the absorption maxima is in the visible part of the spectrum.

3. Electrochromic device of claim 1, wherein the redox state which absorbs at long wavelength is present either with the σ-bond open or closed, where this redox state which absorbs at long wavelength can be generated either by reduction or by oxidation.

4. Electrochromic device of claim 1, wherein the two redox states OX₂ and RED₂ or RED₁ and OX₁ of the electrochromic compound correspond to one of the following types 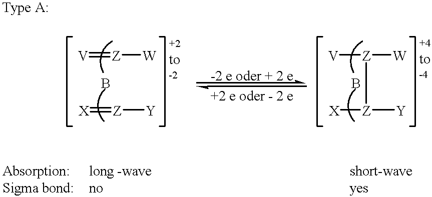 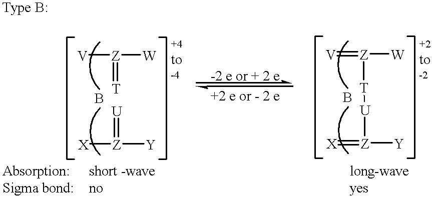
in which
the units V═Z—W and X═Z—Y which absorb at long wavelength represent methine dyes and
B represents a bridge.

5. The electrochromic device of claim 1, wherein at least one OX₂ conforms to the formula (I) 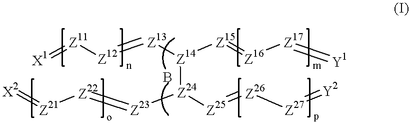
in which X¹, X², Y¹ and Y², independently of one another, are a hetero atom, such as N, O, S, Se or P, which, in the case of O, S and Se, may also carry a substituent and is then positively charged and in the case of N and P may also carry two substituents and in the second case is positively charged,
Z¹¹ to Z¹⁷ and Z²¹ to Z²⁷, independently of one another, are C, which also carries a substituent, or N,
B is a bridge formed between one of the atoms in the group X¹, Z¹¹ to Z¹³, Z¹⁵ to Z¹⁷ and Y¹, and one of the atoms in group X², Z²¹ to Z²³, Z²⁵ to Z²⁷ and Y², and
n, m, o and p, independently of one another, are an integer from 0 to 5.

6. The electrochromic device of claim 1, wherein at least one RED₁ conforms to the formula (II) 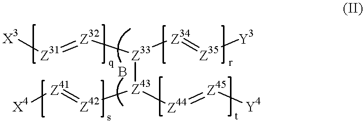
in which
X³, X⁴, Y³ and Y⁴, independently of one another, are a hetero atom, such as N, O, S, Se or P, which, in the case of O, S and Se, also carries a substituent or a negative charge and in the case of N and P also carries two substituents,
Z³¹ to Z³⁵ and Z⁴¹ to Z⁴⁵, independently of one another, are C, which also carries a substituent, or N,
B is a bridge formed between one of the atoms in the group X³, Z³¹, Z³², Z³⁴, Z³⁵ and Y³ and one of the atoms in the group X⁴, Z⁴¹, Z⁴² Z⁴⁴, Z⁴⁵ and Y⁴, and
q, r, s and t, independently of one another, are an integer from 0 to 5.

7. The electrochromic device of claim 5, wherein at least one atom X¹, X², Y¹ or Y², or X³, X⁴, Y³ or Y⁴ is a constituent of a heterocyclic ring.

8. The electrochromic device of claim 1, wherein at least one RED₁ conforms to the formula (III) 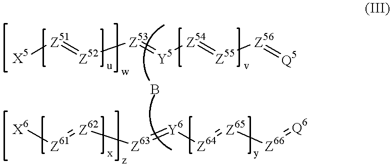
in which
X⁵ and X⁶, independently of one another, are a hetero atom, such as N, O, S, Se or P, which, in the case of O, S and Se, also carries a substituent or a negative charge and in the case of N and P also carries two substituents,
Y⁵ and Y⁶, independently of one another, are a hetero atom, such as N or P, or C, which also carries a substituent,
Q⁵ and Q⁶, independently of one another, are a hetero atom, such as N or P, which also carry a substituent, or C, which also carries two substituents,
Z⁵¹, Z⁵², Z⁵⁴ to Z⁵⁶ and Z⁶¹ Z⁶², Z⁶⁴ to Z⁶⁶, independently of one another, are C, which also carries a substituent, or N,
Z⁵³ to Z⁶³ are C, which also carries a substituent if w or z is 1,
B is a bridge formed between one of the atoms in the group X⁵, Z⁵¹ to Z⁵⁶ and Q⁵ and one of the atoms in the group X⁶, Z⁶¹ to Z⁶⁶ and Q⁶,
w and z, independently of one another, are 1 or 2, and
u, v, x and y, independently of one another, are an integer from 0 to 5.

9. The electrochromic device of claim 8, wherein a bridge B is formed between one of the atoms in the group Z⁵⁴ to Z⁵⁶ and Q⁵ and one of the atoms in the group Z⁶⁴ to Z⁶⁶ and Q⁶, where the corresponding atom Z⁵⁴ Z⁵, Z⁵⁶, Z⁶⁴. Z⁶⁵ or Z⁶⁶ must be C.

10. The electrochromic device of claim 1, wherein the methine dyes formed by oxidative or reductive bond breaking or bond formation belong to a class selected from the group consisting of streptocyanines, hemicyanines, phenylogous hemicyanines, cyanines, oxonols, betaines, neutromethines, phenazines, oxazines, thiazines, bisazines, optionally bridged diphenylmethanes, optionally bridged triphenylmethanes, (mono- or di)phenyl(mono- or di)heteroarylmethanes, triheteroarylmethanes, acridines, xanthenes and thioxanthenes.

11. The electrochromic device of claim 5, wherein, in the formula (I) and/or (II) and/or (III), in each case the pairs X¹ and X², X³ and X⁴, X⁵ and X⁶, Y¹ and Y², Y³ and Y⁴, Y⁵ and Y⁶, Z¹¹ and Z²¹, Z¹² and Z²², Z¹³ and Z²³, Z¹⁴ and Z²⁴, Z¹⁵ and Z²⁵, Z¹⁶ and Z²⁶, Z¹⁷ and Z²⁷, Z³¹ and Z⁴¹, Z³² and Z⁴², Z³³ and Z⁴³, Z³⁴ and Z⁴⁴, Z³⁵ and Z⁴⁵, Z⁵¹ and Z⁶¹, Z⁵² and Z⁶², Z⁵³ and Z⁶³, Z⁵⁴ and Z⁶⁴, Z⁵⁵ and Z⁶⁵, Z⁵⁶ and Z⁶⁶, Q⁵ and Q⁶, n and o, m and p, q and s, r and t, u and x, v and y, w and z, are identical.

12. An electrochromic compound in which two identical or different coloring units are linked via at least one bridge in such a way that, on oxidation or reduction, a σ-bond is formed or broken between the two units, with a color change of the compound in question.

13. The electrochromic compound RED₁ or OX₂ of claim 12, wherein two redox states, which interconvert through the formation or breaking of a σ-bond, have absorption maxima which differ by at least 70 nm, preferably by at least 100 nm, where at least one of the absorption maxima is in the visible part of the spectrum.

14. The electrochromic compound RED₁ or OX₂ of claim 12, wherein the redox state which absorbs at long wavelength exists either with the σ-bond open or closed, where this redox state which absorbs at long wavelength can be generated either by reduction or by oxidation.

15. The electrochromic compound of claim 12, wherein it conforms to one of the redox states of the following types: 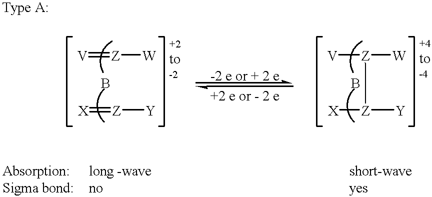
or 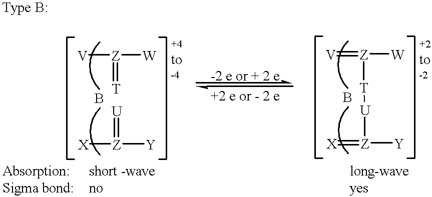
in which the units V═Z—W and X═Z—Y which absorb at long wavelength represent methine dyes and
B represents a bridge.

16. The electrochromic compound of claim 12, wherein it conforms to the formula (I) [chemical structure]
in which
X¹, X², Y¹ and Y², independently of one another, are a hetero atom, such as N, O, S, Se or P, which, in the case of O, S and Se, may also carry a substituent and is then positively charged and in the case of N and P may also carry two substituents and in the second case is positively charged, Z¹¹ to Z¹⁷ and Z²¹ to Z²⁷, independently of one another, are C, which also carries a substituent, or N.
B is a bridge formed between one of the atoms in the group X¹, Z¹¹ to Z¹³, Z¹⁵ to Z¹⁷ and Y¹, and one of the atoms in group X², Z²¹ to Z²³, Z²⁵ to Z²⁷ and Y², and
n, m, o and p, independently of one another, are an integer from 0 to 5.

17. The electrochromic compound of claim 12, wherein the compound comprises a compound having the formula (II) [chemical structure]
in which
X³, X⁴, Y³ and Y⁴, independently of one another, are a hetero atom, such as N, O, S, Se or P, which, in the case of O, S and Se, also carries a substituent or a negative charge and in the case of N and P also carries two substituents,
Z³¹ to Z³⁵ and Z⁴¹ to Z⁴⁵, independently of one another, are C, which also carries a substituent, or N,
B is a bridge formed between one of the atoms in the group X³, Z³¹, Z³², Z³⁴, Z³⁵ and Y³ and one of the atoms in the group X⁴, Z⁴¹, Z⁴², Z⁴⁴, Z⁴⁵ and Y⁴, and
q, r, s and t, independently of one another, are an integer from 0 to 5,
with the restriction that it is not simultaneously the case that X³, X⁴, Y³ and Y⁴ are dimethylamino or methoxy or X³-X⁴ and/or Y³-Y⁴ are a bridge of the formula —O—,
(Z³¹═Z³²)_{q}, (Z⁴¹═Z⁴²)ₛ, (Z³⁴═Z³⁵)ᵣ and(Z⁴⁴═Z⁴⁵)ₜ are o- or p-phenylene,
Z³³-Z⁴³ are a tetravalent radical of the formula 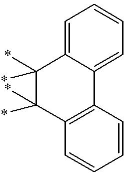
in which the bonds denoted by asterisks (*) are the linking points.

18. The electrochromic compound of claim 12, wherein the compound comprises the formula (III) [chemical structure]
wherein
X⁵ and X⁶, independently of one another, are a hetero atom, such as N, O, S, Se or P, which, in the case of O, S and Se, also carries a substituent or a negative charge and in the case of N and P also carries two substituents,
Y⁵ and Y⁶, independently of one another, are a hetero atom, such as N or P, or C, which also carries a substituent, Q⁵ and Q⁶, independently of one another, are a hetero atom, such as N or P, which also carry a substituent, or C, which also carries two substituents,
Z⁵¹, Z⁵², Z⁵⁴ to Z⁵⁶ and Z⁶¹, Z⁶², Z⁶⁴ to Z⁶⁶, independently of one another, are C, which also carries a substituent, or N,
Z⁵³ to Z⁶³ are C, which also carries a substituent if w or z is 1,
B is a bridge formed between one of the atoms in the group X⁵, Z⁵¹ to Z⁵⁶ and Q⁵ and one of the atoms in the group X⁶, Z⁶¹ to Z⁶⁶ and Q⁶,
w and z, independently of one another, are 1 or 2, and
u, v, x and y, independently of one another, are an integer from 0 to 5.

19. The electrochromic compound of claim 16, wherein the bridge B formed by the substituents of two atoms in the groups X, Y, Z or Q results in the formation of a six-membered ring.

20. An electrochromic medium selected from the group consisting of [chemical structure]
and [chemical structure]
wherein the units V═Z—W and X═Z—Y which absorb at long wavelength represent methine dyes and
B represents a bridge;

21. An electrochromic medium which is selected from the group consisting of
a compound of formula (I) [chemical structure]
in which
X¹, X², Y¹ and Y², independently of one another, are a hetero atom, such as N, O, S, Se or P, which, in the case of O, S and Se, may also carry a substituent and is then positively charged and in the case of N and P may also carry two substituents and in the second case is positively charged, Z¹¹ to Z¹⁷ and Z²¹ to Z²⁷, independently of one another, are C, which also carries a substituent, or N,
B is a bridge formed between one of the atoms in the group X¹, Z¹¹ to Z¹³, Z¹⁵ to Z¹⁷ and Y¹, and one of the atoms in group X², Z²¹ to Z²³, Z²⁵ to Z²⁷ and Y², and n, m, o and p, independently of one another, are an integer from 0 to 5;
a compound of formula (II) [chemical structure]
in which
X³_{,} X⁴, Y³ and Y⁴, independently of one another, are a hetero atom, such as N, O, S, Se or P, which, in the case of O, S and Se, also carries a substituent or a negative charge and in the case of N and P also carries two substituents,
Z³¹ to Z³⁵ and Z⁴¹ to Z⁴⁵, independently of one another, are C, which also carries a substituent, or N,
B is a bridge formed between one of the atoms in the group X³, Z³¹, Z³², Z³⁴, Z³⁵ and Y³ and one of the atoms in the group X⁴, Z⁴¹, Z⁴² Z⁴⁴, Z⁴⁵ and Y⁴, and
q, r, s and t, independently of one another, are an integer from 0 to 5,
with the restriction that it is not simultaneously the case that
X³, X⁴, Y³ and Y⁴ are dimethylamino or methoxy or X³-X⁴ and/or Y³-Y⁴ are a bridge of the formula —O—,
(Z³¹═Z³²)_{q}, (Z⁴¹═Z⁴²)ₛ, (Z³⁴═Z³⁵)ᵣ and (Z⁴⁴═Z⁴⁵)ₜ are o- or p-phenylene,
Z³³-Z⁴³ are a tetravalent radical of the formula 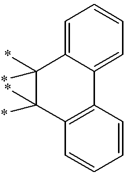
in which the bonds denoted by asterisks (*)are the linking points; and
a compound of formula (III) [chemical structure]
wherein
X⁵ and X⁶, independently of one another, are a hetero atom, such as N, O, S, Se or P, which, in the case of O, S and Se, also carries a substituent or a negative charge and in the case of N and P also carries two substituents,
Y⁵ and Y⁶, independently of one another, are a hetero atom, such as N or P, or C, which also carries a substituent, Q⁵ and Q⁶, independently of one another, are a hetero atom, such as N or P, which also carry a substituent, or C, which also carries two substituents,
Z⁵¹, Z⁵², Z⁵⁴ to Z⁵⁶ and Z⁶¹, Z⁶², Z⁶⁴ to Z⁶⁶, independently of one another, are C, which also carries a substituent, or N,
Z⁵³ to Z⁶³ are C, which also carries a substituent if w or z is 1, B is a bridge formed between one of the atoms in the group X⁵, Z⁵¹ to Z⁵⁶ and Q⁵ and one of the atoms in the group X⁶, Z⁶¹ to Z⁶⁶ and Q⁶
w and z, independently of one another, are 1 or 2, and
u, v, x and y, independently of one another, are an integer from 0 to 5.

22. The electrochromic device of claim 1, wherein the device is a window.

23. The electrochromic device of claim 1, wherein the device is a dividing panel.

24. The electrochromic device of claim 1, wherein the device is a display device.
